(19) United States
(12) Patent Application Publication
(10) Pub. No.: US 2009/0243443 A1
(43) Pub. Date: Oct. 1, 2009

(54) Drive unit

(75) Inventors: Kazuo Aoki, Anjo (JP); Junji Tsuruoka, Anjo (JP); Tomoo Atarashi, Kariya (JP); Takafumi Koshida, Anjo (JP); Manabu Miyazawa, Anjo (JP); Tatsuyuki Uechi, Toyoake (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/314,058

(22) Filed: Dec. 3, 2008

(30) Foreign Application Priority Data
Mar. 31, 2008 (JP) 2008-090824

(51) Int. Cl. H02K 11/00

(52) U.S. Cl. 310/68 D

(57) ABSTRACT

A drive unit includes a rotary electric machine; an inverter used to control the rotary electric machine and a capacitor that smooths a power supply voltage of the inverter; and a case housing the rotary electric machine. A control equipment housing space structured by an inverter housing space portion that houses the inverter and a capacitor housing space portion that houses the capacitor is formed in the case on an outer side of the rotary electric machine in an axial center radial direction of the rotary electric machine. A refrigerant flow chamber through which a refrigerant flows is formed between the control equipment housing space and the rotary electric machine. A capacitor heat exchange fin that performs heat exchange between the capacitor housing space portion and the refrigerant is provided between the capacitor housing space portion and the refrigerant flow chamber.

### INCORPORATION BY REFERENCE

The disclosure of Japanese Patent Application No. 2008-090824 filed on Mar. 31, 2008 including the specification, drawings and abstract is incorporated herein by reference in its entirety.

### BACKGROUND

The present invention relates to a drive unit.

A drive unit including a rotary electric machine such as a motor or a generator, a control device for controlling the rotary electric machine, and a case housing the rotary electric machine and the control device is used favorably in various types of vehicles including a hybrid vehicle and an electric vehicle. The control device of this type of drive unit includes an inverter and a capacitor for smoothing a power supply voltage of the inverter. The control device functions to convert a direct current supplied from a battery into a three-phase current by driving a driving inverter formed by a bridge circuit, and to supply the respective phase currents to a drive motor (a type of rotary electric machine). The control device also functions to convert a three-phase current supplied from a generator motor (a type of rotary electric machine) into a direct current by driving a power generation inverter formed by a bridge circuit, and to supply the direct current to the battery.

To reduce the size of the drive unit, placement of the control device must be taken into account. It is particularly important to consider the placement of the inverter and capacitor, both of which are weak with respect to thermal loads. For example, a drive unit described in Japanese Patent Application Publication No. JP-A-2000-217205 (paragraphs 0008-0012, FIG. 1) includes: a generator motor disposed on a first axis line; a drive motor disposed on a second axis line parallel with the first axis line; a drive unit case housing the generator motor and the drive motor; an inverter for the generator motor and the drive motor; and a smoothing capacitor for smoothing a power supply voltage of the inverter, wherein the inverter is positioned in a radial direction of the generator motor and the drive motor so as to be mounted in the drive unit case, and the smoothing capacitor is mounted in the interior of the drive unit case such that an edge portion thereof projects. In other words, the inverter and smoothing capacitor are formed integrally with the drive unit and the smoothing capacitor is mounted in the drive unit case such that an edge portion thereof projects. As a result, dead space in the interior of the drive unit is used effectively, and a drive unit having an overall compact structure is realized.

### SUMMARY

In the above-described drive unit, the inverter can be cooled by cooling water. Meanwhile, the smoothing capacitor is disposed in the vicinity of a recess portion provided in the drive unit case and extending toward the interior thereof. Since the drive unit case has high thermal conductivity, the smoothing capacitor receives a large thermal load.

In consideration of the circumstances described above, an object of the present invention is to provide a drive unit employing a structure that reduces a thermal load of a capacitor while maintaining an overall compact structure. The present invention can also achieve various other advantages.

According to an exemplary aspect of the invention, a drive unit includes a rotary electric machine; an inverter used to control the rotary electric machine and a capacitor that smooths a power supply voltage of the inverter; and a case housing the rotary electric machine. A control equipment housing space structured by an inverter housing space portion that houses the inverter and a capacitor housing space portion that houses the capacitor is formed in the case on an outer side of the rotary electric machine in an axial center radial direction of the rotary electric machine. A refrigerant flow chamber through which a refrigerant flows is formed between the control equipment housing space and the rotary electric machine. A capacitor heat exchange fin that performs heat exchange between the capacitor housing space portion and the refrigerant is provided between the capacitor housing space portion and the refrigerant flow chamber.

### BRIEF DESCRIPTION OF THE DRAWINGS

Various exemplary aspects of the invention will be described with reference to the drawings, wherein:

FIG. 1 is a sectional view showing a state in which a cover of a drive unit according to an embodiment of the present invention is removed;

FIG. 2 is a side view of the drive unit shown in FIG. 1;

FIG. 3 is a bottom view of the drive unit shown in FIG. 1;

FIG. 4 is a pattern diagram of the drive unit; and

FIG. 5 is an exploded pattern diagram of a refrigerant flow chamber.

### DETAILED DESCRIPTION OF EMBODIMENTS

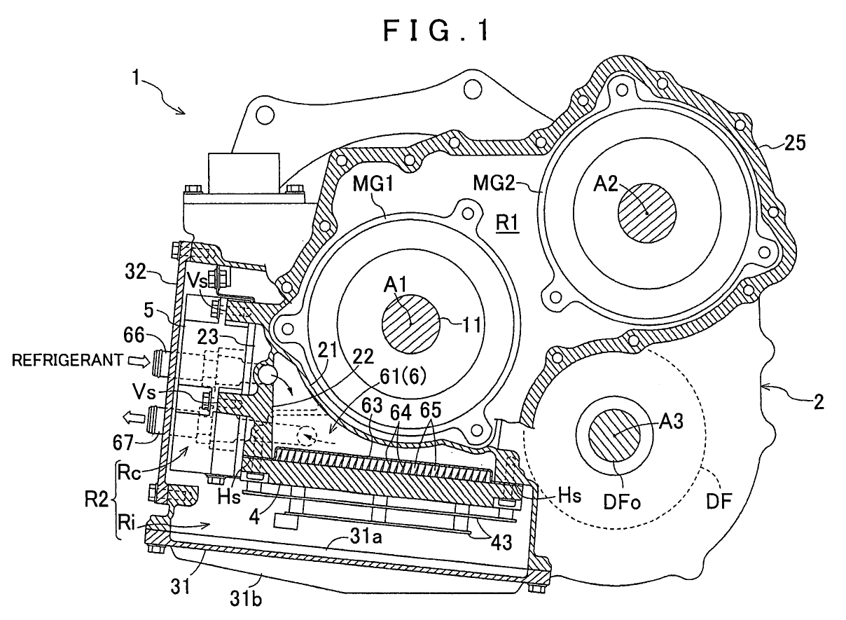

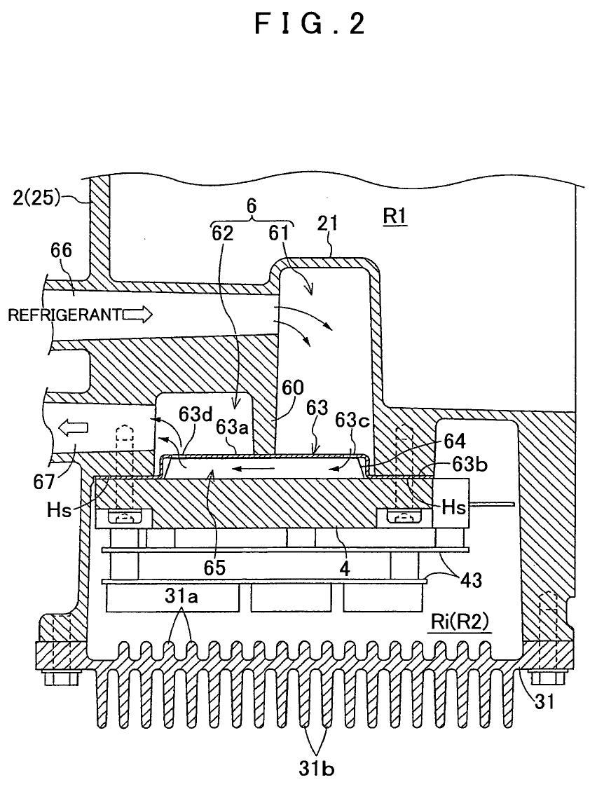

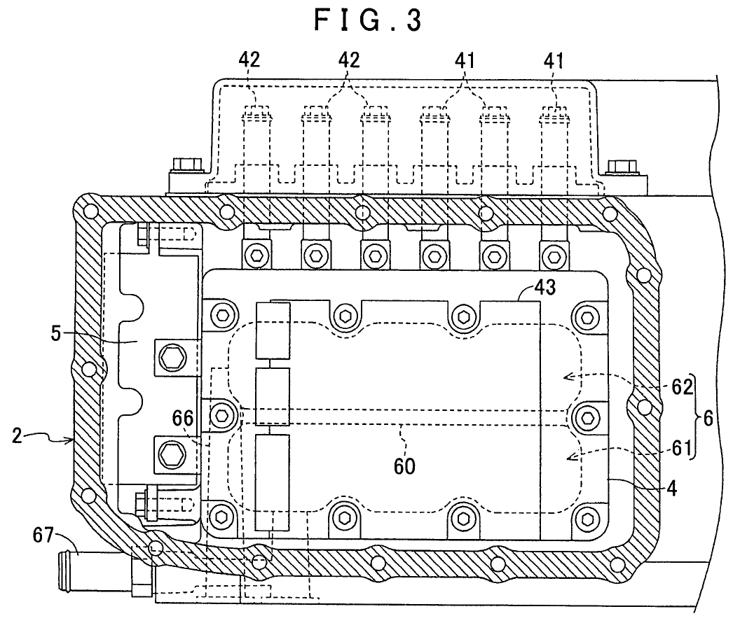

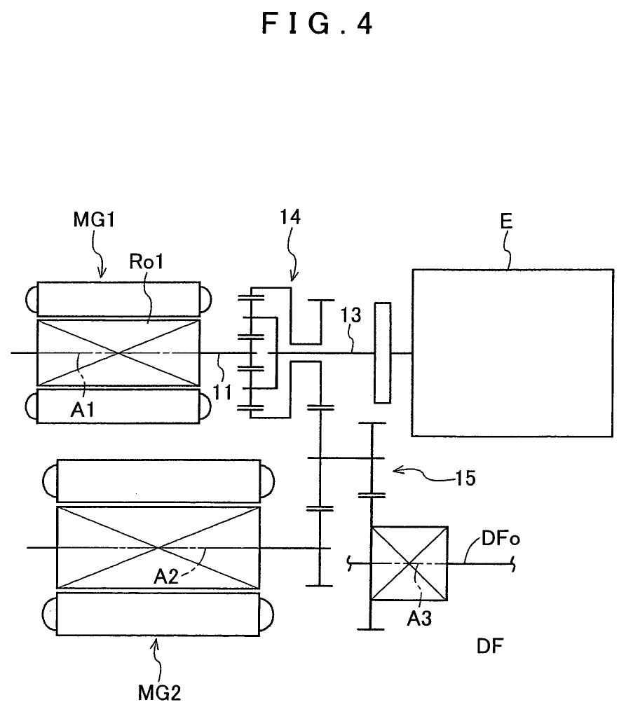

An embodiment of the present invention will be described below on the basis of the drawings. Here, a case in which the present invention is applied to a drive unit 1 for a hybrid vehicle will be described as an example. FIG. 1 is a sectional view of the drive unit 1 according to this embodiment. FIG. 2 is a side view of the drive unit 1 shown in FIG. 1 when viewed from the left side. In this side view, a side cover 32 covering a capacitor housing space portion and a capacitor 5 have been removed, and a refrigerant flow chamber is shown in cross-sectional form. FIG. 3 is a bottom view of the drive unit 1 shown in FIG. 1 when viewed from a lower side. In this bottom view, an under cover 31 covering an inverter housing space portion has been removed. FIG. 4 is a schematic diagram showing an example of a relationship between various power transmission elements of the drive unit 1 and an engine E.

As shown in the drawings, the drive unit 1 according to this embodiment is formed by housing two rotary electric machines, namely a first rotary electric machine MG1 and a second rotary electric machine MG2, and a differential device DF in the interior of a single case 2. Further, in the drive unit 1, an inverter 4 for performing power control of the two rotary electric machines MG1, MG2, a capacitor 5 for smoothing a power supply voltage of the inverter 4, a bus bar, not shown in the drawings, for electrically connecting the inverter 4 to the two rotary electric machines MG1, MG2, and the like are also housed in the interior of the case 2. The case 2 includes a machine housing space R1 housing the rotary electric machines MG1, MG2 and the like, and a control equipment housing space R2 housing the inverter 4, the capacitor 5, and the like. These spaces R1, R2 are separated from each other by a partition wall 21. The structure of each portion of the drive unit according to this embodiment will be described in detail below.

### 1. Structure of Mechanism Portion of Drive Unit

First, an outline of the structure of a mechanism portion of the drive unit 1 according to this embodiment will be described. As shown in FIG. 1, the drive unit 1 includes the two rotary electric machines, namely the first rotary electric machine MG1 and the second electric machine MG2, and the differential device DF. Note that FIG. 1 shows only the outer form of these components, and a detailed depiction of their shape has been omitted. The first rotary electric machine MG1, the second rotary electric machine MG2, and the differential device DF are disposed adjacent to each other in a radial direction, and lines linking the axes thereof are disposed to form a triangle. Here, the axis of the first rotary electric machine MG1 (more specifically, a rotary axis of a rotor of the first rotary electric machine MG1) is set as a first axis A1, the axis of the second rotary electric machine MG2 (more specifically, a rotary axis of a rotor of the second rotary electric machine MG2) is set as a second axis A2, and the axis of the differential device DF (an output shaft of the differential device DF) is set as a third axis A3. The first axis A1, the second axis A2, and the third axis A3 are disposed parallel to each other. As shown in the drawing, when the first axis A1 is used as a reference, the second axis A2 is disposed upward of the first axis A1 in a vertical direction, and the third axis A3 is disposed downward of the first axis A1 in the vertical direction. In a horizontal direction, the second axis A2 and the third axis A3 are both disposed on one side (the right side in FIG. 1) of the first axis A1, the second axis A2 being disposed slightly to one side (the right side in FIG. 1) of the third axis A3. Further, the first rotary electric machine MG1 and the second rotary electric machine MG2 are disposed in overlapping positions in an axial direction of the first axis A1 (a perpendicular direction to the paper surface in FIG. 1). Thus, the overall length of the drive unit 1 in the axial direction can be kept short. The first rotary electric machine MG1, the second rotary electric machine MG2, and the differential device DF are housed in the machine housing space R1 of the case 2.

As shown in FIG. 4, the first rotary electric machine MG1 and a rotary shaft 11 of a rotor Ro1 thereof, an input shaft 13 connected to an output shaft of the engine E, and a planetary gear speed change mechanism 14 for transmitting the rotation of the first rotary electric machine MG1 and the input shaft 13 to the differential device DF side are disposed on the first axis A1. The planetary gear speed change mechanism 14 is structured to be capable of transmitting the rotation of the first rotary electric machine MG1 and the input shaft 13 to the differential device DF side using a gear transmission mechanism 15 as a relay. The gear transmission mechanism 15 functions to relay the rotation of the second rotary electric machine MG2 to the differential device DF side. An output shaft DFo of the differential device DF is drive-connected to a wheel, not shown in the drawing. Accordingly, the rotation of the first rotary electric machine MG1 and the second rotary electric machine MG2 is output to the exterior of the case 2 via the differential device DF as a rotation of the output shaft DFo of the differential device DF, and then transmitted to the wheel.

### 2. Structure of Case and Cover

As shown in FIGS. 1 and 2, the case 2 includes the machine housing space R1 housing the rotary electric machines MG1, MG2, and the like, and the control equipment housing space R2 housing the inverter 4, the capacitor 5, and the like. The machine housing space R1 and the control equipment housing space R2 are separated from each other by the partition wall 21. In this embodiment, as described above, the machine housing space R1 houses the first rotary electric machine MG1, the second rotary electric machine MG2, the differential device DF, and the planetary gear speed change mechanism 14.

An outer periphery wall 25 forming the outer form of the case 2 is formed in an irregular tubular shape having an axis that is substantially parallel to the respective axes of the first rotary electric machine MG1, the second rotary electric machine MG2, and the differential device DF (the first axis A1, the second axis A2 and the third axis A3). The machine housing space R1 has a substantially parallel axis to the respective axes of the first rotary electric machine MG1, the second rotary electric machine MG2, the differential device DF, the planetary gear speed change mechanism 14, and the like (the first axis A1, the second axis A2 and the third axis A3), and is formed in an irregular tubular shape that surrounds the outer form of these components. The control equipment housing space R2 is formed to surround a part of a radial direction outer side of the machine housing space R1.

As is evident from FIG. 1, the control equipment housing space R2 is positioned on the outer side of the partition wall 21, which extends in a semicircle so as to follow the outer form of the first rotary electric machine MG1, and extends in an axial center peripheral direction of the first rotary electric machine MG1. The control equipment housing space R2 is formed with an L-shaped cross-section when seen from the direction of FIG. 1, but is divided into a parallel first space portion and a perpendicular second space portion by an auxiliary partition wall 22 extending in a vertical direction. The first space portion and the second space portion are connected at respective ends thereof. The first space portion is used as an inverter housing space Ri for housing the inverter 4, and the second space portion is used as a capacitor housing space Rc.

The inverter 4 is attached by a bolt to a horizontal attachment surface Hs formed on the partition wall 21 and the auxiliary partition wall 22, and takes a substantially horizontal attitude when attached. The capacitor 5 is attached by a bolt to a vertical attachment surface VS formed on a flange portion projecting from the partition wall 21 and the auxiliary partition wall 22, and takes a substantially vertical attitude when attached. Thus, the inverter 4 and the capacitor 5 are arranged side by side in the axial center peripheral direction of the first rotary electric machine MG1. A two-tiered control substrate 43 is attached to a front surface of the inverter 4.

The inverter housing space Ri is covered by an under cover 31, and the capacitor housing space Rc is covered by a side cover 32. Cooling fins 31a and 31b are formed respectively on an inside surface and an outside surface of the under cover 31 to enhance a cooling effect on the inverter housing space Ri. Note that the cooling fins 31a and 31b extend parallel to a flow direction of running wind of the vehicle.

As shown in FIG. 3, the inverter 4 includes three terminals 41 connected to U-phase, V-phase and W-phase coils of the first rotary electric machine MG1, and three terminals 42 connected to U-phase, V-phase and W-phase coils of the second rotary electric machine MG2. The respective terminals 41 and 42 of the inverter 4 are connected to the respective phase coils of the rotary electric machines MG1, MG2 via a bus bar, not shown in the drawing, whereby the inverter 4 supplies alternating current power to the rotary electric machines MG1, MG2 and receives a supply of power generated by the rotary electric machines MG1, MG2. Note that a connecting wire between the inverter 4 and the capacitor 5 is not shown in the drawings.

### 3. Structure of Control Equipment Cooling Structure

A triangular prism-shaped refrigerant flow chamber 6 is formed in a space defined by the inverter 4, the capacitor 5, and the partition wall 21, or in other words a space region surrounded by the auxiliary partition wall 22, the inverter 4, and the partition wall 21. In FIG. 1, the inverter 4 is positioned directly on a lower surface side of the refrigerant flow chamber 6, while the capacitor 5 is positioned on a left surface side of the refrigerant flow chamber 6 on the opposite side of the auxiliary partition wall 22. A gap through which air can flow is formed between the auxiliary partition wall 22 and the capacitor 5. Further, a heat exchange fin 23 is formed on a capacitor 5 side wall surface of the auxiliary partition wall 22 such that heat exchange is performed efficiently between the air that flows between the auxiliary partition wall 22 and the capacitor 5, and the heat exchange fin 23.

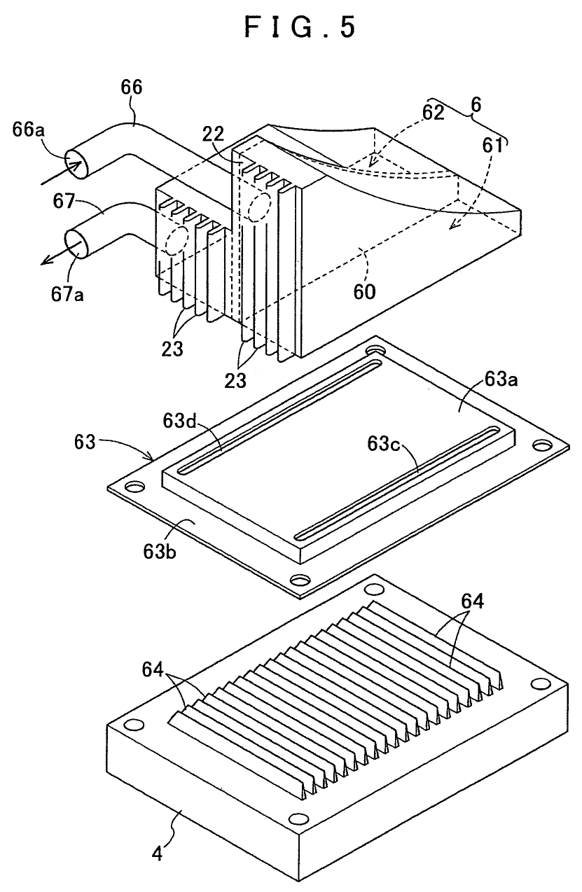

FIG. 5 is an exploded pattern diagram showing the structure of the refrigerant flow chamber 6. As is evident from FIG. 5, the refrigerant flow chamber 6 is divided by a dividing wall 60 into a first refrigerant flow chamber 61 positioned on an upstream side of a refrigerant flow direction and a second refrigerant flow chamber 62 positioned on a downstream side thereof. In other words, the first refrigerant flow chamber 61 and the second refrigerant flow chamber 62 are disposed in series in an axial center direction of the first rotary electric machine MG1. Further, a heat exchange chamber 65 (see FIG. 1) formed from a partition plate 63 and a cooling fin body 64 is inserted between the first refrigerant flow chamber 61 and the second refrigerant flow chamber 62 with respect to the refrigerant flow direction.

The partition plate 63 is structured by a top plate portion 63a that aligns with the lower surfaces of the first refrigerant flow chamber 61, the second refrigerant flow chamber 62, and the dividing wall 60, and a peripheral portion 63b formed such that a space is created on the inside of the top plate portion 63a. In other words, the partition plate 63 takes the form of an edged rectangular parallelepiped container formed by drawing a single flat plate. The cooling fin body 64 has a shape and dimensions that allow it to fit perfectly into the recess portion of the partition plate 63, and by combining the cooling fin body 64 and the partition plate 63, the heat exchange chamber 65 structured by a large number of grooves is created. Further, a first elongated hole 63c forming an inlet into the heat exchange chamber 65 and a second elongated hole 63d forming an outlet from the heat exchange chamber 65 are provided in the two end portions of the top plate portion 63a of the partition plate 63. By structuring the refrigerant flow chamber 6 in this manner, refrigerant flowing into the first refrigerant flow chamber 61 enters the heat exchange chamber 65 through the first elongated hole 63c, and then enters the second refrigerant flow chamber 62 through the second elongated hole 63d.

A refrigerant inflow passage 66 is connected to the first refrigerant flow chamber 61, and a refrigerant outflow passage 67 is connected to the second refrigerant flow chamber 62. The refrigerant inflow passage 66 and the refrigerant outflow passage 67 are L-shaped and disposed on the side of the capacitor 5 in identical positions with respect to the axial center peripheral direction of the first rotary electric machine MG1 such that an inlet 66a of the refrigerant inflow passage 66 is disposed on an upper side and an outlet 67a of the refrigerant outflow passage 67 is disposed on a lower side.

In the embodiment described above, the cooling fins 31a and 31b are formed respectively on the inside surface and the outside surface of only the under cover 31 covering the inverter housing space Ri, but a cooling fin may also be provided on at least one of an inside surface and an outside surface of the side cover 32 covering the capacitor housing space Rc.

The present invention is a drive unit having a rotary electric machine such as a motor or a generator, and may be used favorably as a drive unit suitable for use in various types of vehicles including a hybrid vehicle and an electric vehicle, for example.

Note that in the present invention, the term “rotary electric machine” is used as a concept including any of a motor (electric motor), a generator (electric generator), and if necessary, a motor/generator that functions as both a motor and a generator.

According to an exemplary aspect of the invention, control equipment such as the inverter and the capacitor is disposed on the outside of the rotary electric machine in the axial center radial direction of the rotary electric machine, and therefore the drive unit can be made compact. Meanwhile, by disposing the refrigerant flow chamber through which the refrigerant flows between the control equipment housing space, which houses the inverter, the capacitor, and the like, and the rotary electric machine, thermal conduction from the rotary electric machine to the inverter and the capacitor is suppressed. Moreover, the capacitor heat exchange fin for performing heat exchange between the capacitor housing space portion and the refrigerant is provided between the capacitor housing space portion and the refrigerant flow chamber. Thus, temperature increases in the capacitor housing space portion are suppressed, leading to an improvement in the thermal environment of the capacitor and a reduction in the thermal load of the capacitor.

Further, the control equipment housing space preferably extends in an axial center peripheral direction of the rotary electric machine, and the inverter and the capacitor are preferably arranged in series in the axial center peripheral direction. According to an exemplary aspect of the invention, the inverter and the capacitor are arranged around the outer peripheral contour of the rotary electric machine such that, even when the inverter and the capacitor are provided integrally, the outer form of the drive unit can be reduced in size in both a radial direction and an axial direction of the rotary electric machine.

Further, the control equipment housing space is preferably a substantially L-shaped space in which a first space portion and a second space portion extending in a substantially orthogonal direction to each other are connected by respective ends thereof, the first space portion being used as the inverter housing space portion and the second space portion being used as the capacitor housing space portion. The inverter is housed in the first space portion, which serves as one side of the control equipment housing space formed as a substantially L-shaped space, and the capacitor is housed in the second space portion serving as another side. As a result, the refrigerant flow chamber is formed in a substantially triangular prism-shaped dead space that has one curved side face and is formed between the rotary electric machine, the inverter, and the capacitor, thereby making effective use of this space. Furthermore, when the refrigerant flow chamber is formed to conform to this substantially triangular prism-shaped space (dead space) defined by the substantially L-shaped control equipment housing space and an outer peripheral surface of the rotary electric machine, effective use of space and a superior cooling effect on the capacitor and the inverter can both be obtained.

Further, when a preferred structure in which the first space portion is provided below the rotary electric machine and the second space portion is provided to a side of the rotary electric machine is employed, the capacitor housing space is positioned in an upper position where heat gathers easily, but temperature increases in the capacitor housing space portion are suppressed effectively by the capacitor heat exchange fin.

Further, by mounting the capacitor in the second space portion so as to face the capacitor heat exchange fin with a predetermined gap therebetween, air cooled by the heat exchange fin passes through the surface of the capacitor facing the rotary electric machine, and therefore the thermal environment of the capacitor can be improved.

Further, an inflow passage and an outflow passage relating to the refrigerant flow chamber are preferably provided on the capacitor housing space portion side. According to an exemplary aspect of the invention, an advantage is obtained in that the capacitor housing space portion is also cooled by the inflow passage and the outflow passage for the refrigerant.

Further, a cover which covers an interior of the control equipment housing space when attached to the case is preferably disposed on an opposite side of the control equipment housing space to the rotary electric machine, and a cooling fin is preferably provided on both an outer surface and an inner surface of the cover. According to an exemplary aspect of the invention, the control equipment housing space can be cooled effectively by the cooling fins. Cooling fins are preferably provided on the respective covers of the inverter housing space portion and the capacitor housing space portion, but as long as a cooling fin is provided on one of the covers, for example, the cover covering the interior of the inverter housing space, a considerable cooling effect can be obtained and temperature increases in the capacitor housing space portion can be suppressed thereby.

What is claimed is:

1. A drive unit comprising:
a rotary electric machine;
an inverter used to control the rotary electric machine and a capacitor that smooths a power supply voltage of the inverter; and
a case housing the rotary electric machine, wherein:
a control equipment housing space structured by an inverter housing space portion that houses the inverter and a capacitor housing space portion that houses the capacitor is formed in the case on an outer side of the rotary electric machine in an axial center radial direction of the rotary electric machine,
a refrigerant flow chamber through which a refrigerant flows is formed between the control equipment housing space and the rotary electric machine, and
a capacitor heat exchange fin that performs heat exchange between the capacitor housing space portion and the refrigerant is provided between the capacitor housing space portion and the refrigerant flow chamber.

2. The drive unit according to claim 1, wherein the control equipment housing space extends in an axial center peripheral direction of the rotary electric machine, and the inverter and the capacitor are arranged in series in the axial center peripheral direction.

3. The drive unit according to claim 2, wherein the control equipment housing space is a substantially L-shaped space in which a first space portion and a second space portion extending in a substantially orthogonal direction to each other are connected by respective ends thereof, the first space portion being used as the inverter housing space portion and the second space portion being used as the capacitor housing space portion.

4. The drive unit according to claim 3, wherein the first space portion is provided below the rotary electric machine, and the second space portion is provided to a side of the rotary electric machine.

5. The drive unit according to claim 3, wherein the capacitor is mounted in the second space portion so as to face the capacitor heat exchange fin with a predetermined gap therebetween.

6. The drive unit according to claim 3, wherein the refrigerant flow chamber is formed to conform to a substantially triangular prism-shaped space defined by the substantially L-shaped control equipment housing space and an outer peripheral surface of the rotary electric machine.

7. The drive unit according to claim 3, wherein an inflow passage and an outflow passage relating to the refrigerant flow chamber are provided on the capacitor housing space portion side.

8. The drive unit according to claim 1, wherein a cover that covers an interior of the control equipment housing space when attached to the case is disposed on an opposite side of the control equipment housing space to the rotary electric machine, and a cooling fin is provided on both an outer surface and an inner surface of the cover.

9. The drive unit according to claim 4, wherein the capacitor is mounted in the second space portion so as to face the capacitor heat exchange fin with a predetermined gap therebetween.

10. The drive unit according to claim 4, wherein the refrigerant flow chamber is formed to conform to a substantially triangular prism-shaped space defined by the substantially L-shaped control equipment housing space and an outer peripheral surface of the rotary electric machine.

11. The drive unit according to claim 9, wherein the refrigerant flow chamber is formed to conform to a substantially triangular prism-shaped space defined by the substantially L-shaped control equipment housing space and an outer peripheral surface of the rotary electric machine.

12. The drive unit according to claim 4, wherein an inflow passage and an outflow passage relating to the refrigerant flow chamber are provided on the capacitor housing space portion side.

13. The drive unit according to claim 5, wherein an inflow passage and an outflow passage relating to the refrigerant flow chamber are provided on the capacitor housing space portion side.

14. The drive unit according to claim 6, wherein an inflow passage and an outflow passage relating to the refrigerant flow chamber are provided on the capacitor housing space portion side.

15. The drive unit according to claim 9, wherein an inflow passage and an outflow passage relating to the refrigerant flow chamber are provided on the capacitor housing space portion side.

16. The drive unit according to claim 11, wherein an inflow passage and an outflow passage relating to the refrigerant flow chamber are provided on the capacitor housing space portion side.

17. The drive unit according to claim 2, wherein a cover that covers an interior of the control equipment housing space when attached to the case is disposed on an opposite side of the control equipment housing space to the rotary electric machine, and a cooling fin is provided on both an outer surface and an inner surface of the cover.

18. The drive unit according to claim 3, wherein a cover that covers an interior of the control equipment housing space when attached to the case is disposed on an opposite side of the control equipment housing space to the rotary electric machine, and a cooling fin is provided on both an outer surface and an inner surface of the cover.

19. The drive unit according to claim 4, wherein a cover that covers an interior of the control equipment housing space when attached to the case is disposed on an opposite side of the control equipment housing space to the rotary electric machine, and a cooling fin is provided on both an outer surface and an inner surface of the cover.

20. The drive unit according to claim 5, wherein a cover that covers an interior of the control equipment housing space when attached to the case is disposed on an opposite side of the control equipment housing space to the rotary electric machine, and a cooling fin is provided on both an outer surface and an inner surface of the cover.
